(19) United States
(12) Patent Application Publication
(10) Pub. No.: US 2025/0264415 A1
(43) Pub. Date: Aug. 21, 2025

(54) DYNAMIC RANGE EXTENSION OF OPTICAL SYSTEMS WITH MULTIPLE LOW INTENSITY BEAMS

(71) Applicant: KLA Corporation, Milpitas, CA (US)

(72) Inventors: Frank Li, Danville, CA (US); Steve Zhiwei Xu, Sunnyvale, CA (US); Christian Wolters, San Jose, CA (US); Bret Whiteside, San Jose, CA (US)

(21) Appl. No.: 19/012,641

(22) Filed: Jan. 7, 2025

Related U.S. Application Data
(60) Provisional application No. 63/555,902, filed on Feb. 21, 2024.

(51) Int. Cl. G01N 21/88; H04N 23/56; H04N 23/71; H04N 23/74; H04N 23/75

(52) U.S. Cl. CPC G01N 21/8806; H04N 23/56; H04N 23/71; H04N 23/74; H04N 23/75; G01N 2021/8835; G01N 2021/8845; G01N 21/8851

(57) ABSTRACT

Methods and systems for extending the dynamic range of imaging systems are provided. One system includes an optical element that separates a light beam into a primary beam and one or more pairs of secondary beams. The secondary beams in each pair are located on opposite sides of the primary beam, respectively. The primary beam has a higher intensity than all of the secondary beams. Focusing optics simultaneously focus the primary beam and the secondary beams to different, spatially separated spots, respectively, in an imaging plane of the system. The system illuminates the specimen with the different, spatially separated spots. The optical element is preferably configured so that light from the spots on the specimen illuminated with the primary beam and all of the secondary beams on at least one side of the primary beam are incident on a field of view of a detector of the system.

### BACKGROUND OF THE INVENTION

### 1. Field of the Invention

This invention generally relates to methods and systems for generating multiple light beams for illumination of a specimen and/or determining information for a specimen. Certain embodiments relate to extending the dynamic range of an optical system by illuminating a specimen with beams of different intensity and using only one of the resulting unsaturated, detector outputs for determining information for the specimen.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a photomask to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

The configuration of inspection systems can dramatically affect the capability of the tools especially as the structures on the specimens being inspected become much smaller and more complex and/or as the particles or defects on the specimens become significantly smaller. Although nearly every configurable parameter of an inspection system may have an effect on the inspection capability of the system, the primary concern addressed herein is how its various elements and parameters can affect dynamic range of the system.

Some currently used techniques for extending dynamic range of an optical system include using leaked light from the main signal and measuring it on a separate sensor of the same or different type as the main sensor/detector. Another currently used technique for extending the dynamic range of an optical system includes imaging techniques of using the non-saturated part of the saturated optical signal. This technique is only applicable to imaging systems.

There are, however, a number of important disadvantages to the currently used techniques described above. For example, adding an additional sensor/detector and its associated hardware and software can be cost prohibitive in both cost of the sensor/detector and the corresponding electronics and computation. Using a different type of sensor/detector than the main sensor can reduce cost. However, the resultant sensitivity may not be sufficient to cover the dynamic range gaps. In an additional example, imaging methodologies that try to use just the non-saturated part of the image can result in accuracy issues since the entire signal cannot be used and only the tail regions where the signal is not saturated can be used. Thus, relatively small variations in the tail signals can result in a relatively large difference in the results.

Accordingly, it would be advantageous to develop systems and/or methods for generating multiple light beams for illumination of a specimen and/or determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for generating multiple light beams for illumination of a specimen. The system includes an optical element positioned in a path of a light beam from a light source of the system. The optical element is configured for separating the light beam into a primary beam and one or more pairs of secondary beams. The secondary beams in each of the one or more pairs are located on opposite sides of the primary beam, respectively. The optical element is configured such that the primary beam has a higher intensity than all of the secondary beams. Focusing optics of the system are configured for simultaneously focusing the primary beam and the secondary beams to different, spatially separated spots, respectively, in an imaging plane of the system. The system is configured for illuminating the specimen with the different, spatially separated spots in the imaging plane. The system may be further configured as described herein.

Another embodiment relates to a method for generating multiple light beams for illumination of a specimen. The method includes separating a light beam into a primary beam and one or more pairs of secondary beams with an optical element positioned in a path of the light beam from a light source. The secondary beams in each of the one or more pairs are located on opposite sides of the primary beam, respectively, and the primary beam has a higher intensity than all of the secondary beams. The method also includes simultaneously focusing the primary beam and the secondary beams to different, spatially separated spots, respectively, in an imaging plane of the system. In addition, the method includes illuminating the specimen with the different, spatially separated spots in the imaging plane.

The steps of the method may be performed as described further herein. In addition, the method may include any other step(s) of any other method(s) described herein. The method may be performed by any of the systems described herein.

An additional embodiment relates to a system configured for determining information for a specimen. The system includes a light source configured for generating a light beam and an optical element positioned in a path of the light beam and configured as described above. The system also includes focusing optics configured for simultaneously focusing the primary beam and the secondary beams to different, spatially separated spots, respectively, in an imaging plane of the system. In addition, the system includes a detector configured for separately and simultaneously detecting light from the different, spatially separated spots and generating different outputs responsive thereto. The system further includes a computer subsystem configured for determining information for the specimen from the different outputs generated by the detector. The system may be configured as described further herein.

A further embodiment relates to a method for determining information for a specimen. The method includes generating a light beam with a light source and separating the light beam into a primary beam and one or more pairs of secondary beams with an optical element positioned in a path of the light beam. The secondary beams in each of the one or more pairs are located on opposite sides of the primary beam, respectively, and the primary beam has a higher intensity than all of the secondary beams. The method also includes simultaneously focusing the primary beam and the secondary beams to different, spatially separated spots, respectively, in an imaging plane at the specimen. In addition, the method includes separately and simultaneously detecting light from the different, spatially separated spots and generating different outputs responsive thereto. The method further includes determining information for the specimen from the different outputs generated by the detector.

The steps of the method may be performed as described further herein. In addition, the method may include any other step(s) of any other method(s) described herein. The method may be performed by any of the systems described herein.

### BRIEF DESCRIPTION OF THE DRAWINGS

Other objects and advantages of the invention will become apparent upon reading the following detailed description and upon reference to the accompanying drawings in which:

FIG. 1 is a schematic diagram illustrating a perspective view of an embodiment of an optical element configured as described herein for separating a light beam into a primary beam and one or more pairs of secondary beams;

FIG. 2 is a schematic diagram illustrating a side view of an embodiment of an optical element and focusing optics configured as described herein;

FIG. 3 is a schematic diagram illustrating a plan view of an embodiment of locations of light from a specimen due to illumination with the primary and secondary beams described herein in a field of view of a detector;

FIG. 4 is a schematic diagram illustrating a side view of one embodiment of a system configured for generating multiple light beams for illumination of a specimen and determining information for a specimen; and

FIG. 5 is a block diagram illustrating one embodiment of a non-transitory computer-readable medium storing program instructions executable on a computer system for performing one or more of the computer-implemented methods described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

The embodiments described herein generally relate to methods and systems for generating multiple light beams for illumination of a specimen and/or determining information for a specimen. Some embodiments described herein are advantageously configured for dynamic range extension of optical systems such as optical inspection systems by multiple high order beams. For example, the embodiments described herein include an optical element configured to generate multiple high order beams of decreasing intensity to properly measure optical signals that would otherwise be saturated. In terms of the embodiments described herein, the term “saturated” as used with respect to an optical signal or other output described herein is generally defined as a signal or other output that exceeds the maximum value detectable by the detector or sensor. When a detector becomes “saturated,” its output becomes fixed at the maximum value even if the signal is actually greater than the maximum. As such, at saturation, the output generated by a detector is unusable since it probably does not represent an accurate value. In this manner, by accounting for the saturation of detectors as described herein, the dynamic range of systems such as optical inspection systems can be extended.

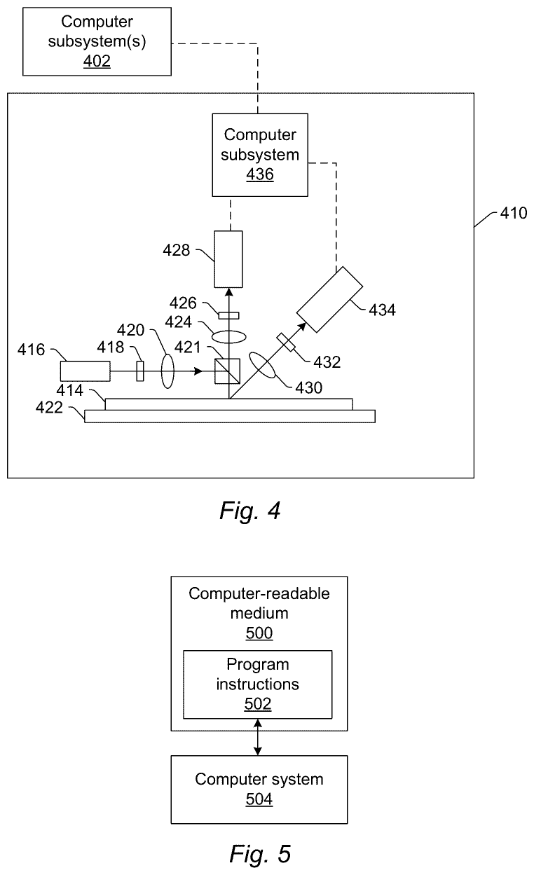

One embodiment of a system configured for generating multiple light beams for illumination of a specimen includes an optical element positioned in a path of a light beam from a light source of the system. In particular, the optical element is positioned in the path of the light from the light source and between the light source and the specimen since, as described further herein, the optical element generates the multiple light beams that are used to illuminate the specimen. One such possible position for the optical element is described further below and shown in FIG. 4. However, the position of the optical element in the path of the illumination light may vary depending on the configuration of the system, other optics in the system, characteristics of the light, and any other parameters normally considered in optical systems design. The optical element described herein may also be incorporated into an existing optical system or may be included in an optical system being designed from scratch. In particular, the embodiments described herein may be advantageous for existing optical systems (either as a permanent or optional feature) and for optical systems currently being developed.

The optical element is configured for separating the light beam into a primary beam and one or more pairs of secondary beams. The terms “secondary beams,” “higher order beams,” and “ghost beams” are used interchangeably herein. The secondary beams may be higher order beams, i.e., beams having a higher order than the primary beam, but in general the secondary beams are simply beams, along with the primary beam, into which a single light beam is separated and which have intensities and other characteristics described herein. The light beam that is incident on (entering) the optical element and the primary beam exiting the optical element will remain essentially the same except for intensity as some of the entering light beam will be diverted from the exiting primary beam to the higher order beams. In other words, the light beam, the primary beam, and the secondary beams will have characteristics other than intensity, e.g., wavelength, polarization, etc., that are the same or substantially the same. In particular, other than separating the single light beam into multiple light beams of different intensity that can separately and simultaneously illuminate different spots on a specimen, the optical element does not intentionally change any other characteristics of the light.

The number of orders of the secondary beams, i.e., how many secondary beams are created from the incoming light beam, is in principle infinite. However, there may be a practical limit on the number of secondary beams that are generated based on the configuration of the system, and, in some instances, the number of secondary beams that are generated and/or used for each application may be selected by a user. For example, the optical element may be designed based on the system configuration and user preferences, and then the same optical element configuration may be used in all applications performed by the system. However, in some instances, one or more characteristics of the optical element may be changed, e.g., for different applications, if possible so that different numbers of beams are generated for different applications performed by the same system.

There are several options that can be used for the optical element and the multiple, higher order beam generation performed therewith. For example, the optical element may include wedged prisms configured for two beam generation with a series of prisms for multi-beam generation. Another example of a suitable optical element configuration includes a system of mirrors with reflective coating control for multi-beam generation. An additional example of a suitable optical element configuration includes a diffraction grating or a diffractive optical element (DOE) for multi-beam (multi-order) generation. In this manner, the optical element may in practice include one or more optical elements, which may include various optical components configured as described herein to generate multiple, higher order beams of decreasing intensity to thereby enable an optical system to extend its dynamic range.

The secondary beams in each of the one or more pairs are located on opposite sides of the primary beam, respectively. In other words, each of the pairs may include two secondary beams, say first and second secondary beams. Then, all of the first secondary beams in each pair may be located on one side of the primary beam, and all of the second secondary beams in each of the pairs may be located on the other side of the primary beam. To state this a different way, secondary beam 1 in pair 1 may be located on side 1 of the primary beam and secondary beam 2 in pair 1 may be located on side 2 of the primary beam. In addition, secondary beam 1 in pair 2 may be located on side 1 of the primary beam, and secondary beam 2 in pair 2 may be located on side 2 of the primary beam, and so on. The first and second sides may be separated by each other by 180 degrees. In other words, the two secondary beams in each of the pairs are on opposite sides of the primary beam, which means that all of the beams are arranged along the same dimension, which is an important feature of the embodiments described herein. In particular, as described further herein, configuring the optical element so that secondary beams of each order are generated on both sides of the primary beam ensures that light from the specimen corresponding to at least one beam of each order is incident on the detector (also referred to interchangeably herein as a “sensor”) even if there is some variation in locations of the light corresponding to the beams on the detector imaging plane.

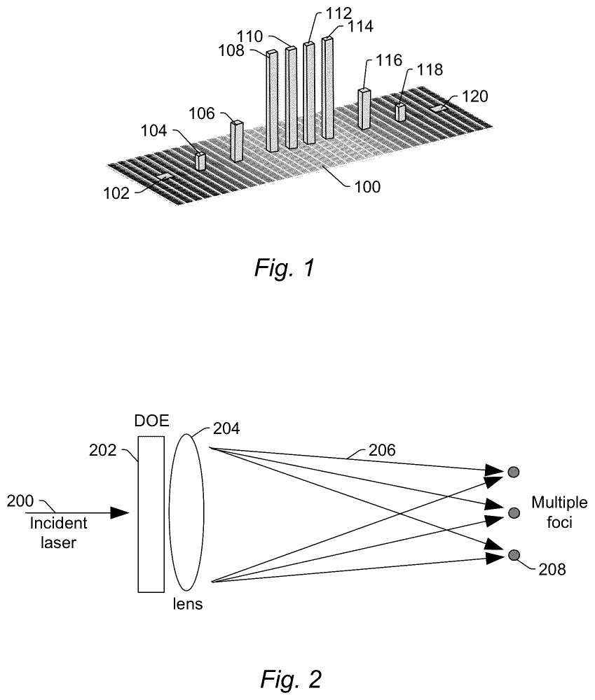

In some embodiments, the primary beam and each of the secondary beams are arranged in a one-dimensional (1D) array. For example, the embodiments are configured for generating the primary beam and secondary beams from the original light beam and directing the primary and secondary beams to an imaging plane of the system and on the sensor/detector of the system in one direction. FIG. 1 shows one embodiment of a 1D multi-spot/beam splitter element configured to generate the multi-spot illumination described herein. In this embodiment, optical element 100 is configured to separate a light beam (not shown in FIG. 1) into different beams including a primary beam (not shown in FIG. 1) and secondary beams. In terms of how the optical element is shown in FIG. 1, the light beam may be directed to the optical element from below the optical element, and the primary beam and secondary beams may exit the optical element from a top surface of the optical element. As shown in FIG. 1, each of the secondary beams 102, 104, 106, 108, 110, 112, 114, 116, 118, and 120 are arranged in a 1D array parallel to one dimension of the optical element.

The relative intensity of each of the beams shown in FIG. 1 are indicated by the different heights of the beams, and the secondary beams are not shown in FIG. 1 to convey any characteristics of the beams other than relative intensity and location. In this manner, FIG. 1 is not meant to illustrate any absolute values of the characteristics of the secondary beams, and while the relative intensities and relative locations of the secondary beams are preferably configured as described herein and illustrated generally in FIG. 1 they may also vary somewhat from that shown in FIG. 1. The secondary beams may include beams 102 and 120 having the lowest intensity of the secondary beams and otherwise configured as a pair of secondary beams as described herein. Beams 104 and 118 may also be a pair of secondary beams configured as described herein and have a second lowest intensity of the secondary beams. Beams 106 and 116 may be the next pair of secondary beams having intensities greater than beams 104 and 118. Beams 108 and 114 may be a pair of secondary beams having the second highest intensity of the secondary beams, and beams 110 and 112 may be a pair of secondary beams having the highest intensity of all of the secondary beams. The primary beam may be positioned between beams 110 and 112.

The optical element is also configured such that the primary beam has a higher intensity than all of the secondary beams. For example, each secondary beam will be at a much lower signal intensity than the primary beam. In particular, as described further herein, the primary beam may have an intensity that is lower than the incoming light beam by only the intensity of the light used to create the secondary beams. Therefore, the intensity of the primary beam will be most similar to the incoming light beam, and each of the secondary beams will have an intensity that is lower (and most likely much lower) than the primary beam. The reason for the different intensities of the primary beam and secondary beams is that, as described further herein, if the light from the specimen due to illumination with the primary beam saturates the detector, then light from the specimen due to illumination with one of the lower intensity, secondary beams may not saturate the detector thereby providing a useable output for the applications described herein. In this manner, the relative intensities of the primary beam and the secondary beams are not merely design choices but enable the embodiments described herein to extend the dynamic range of the optical system.

In one embodiment, the optical element is configured such that the one or more pairs have intensities that decrease as a distance between the one or more pairs and the primary beam increases. For example, each pair of additional higher order ghost beams will be farther away from the primary beam and have lower signal intensity than lower order beams. One example of such a relationship between the distance and intensities is shown in FIG. 1 and described further herein. In other words, as the order of the secondary beams increases, the distance between the secondary beams and the primary beam increases and the intensity of the secondary beams decrease. In this manner, the secondary beams closest to the primary beam will have the highest intensities of the secondary beams, the secondary beams next closest to the primary beam will have the next highest intensities of the secondary beams, and so on. Such relative intensities among the secondary beams will likely be the most common configuration of the optical element, but this relationship between distance from the primary beam and secondary beam intensity is not necessarily the only possibility. For example, as long as the different intensities of the secondary beams are all known and lower than the primary beam, the embodiments can function as described herein.

In some embodiments, the optical element is configured such that each of the secondary beams in at least one of the one or more pairs has the same intensity. In an additional embodiment, the optical element is configured such that each of the secondary beams in each of the one or more pairs has substantially the same intensity. For example, in general, the secondary beams in the pair closest to the primary beam may have the same intensity as each other. The secondary beams in the pair next closest to the primary beam may have the same intensity as each other. The same may be true for all other pairs of secondary beams on either side of the primary beam and of the same order and/or the same distance from the primary beam.

Such a configuration is again not simply a design choice. Instead, as described herein, having secondary beams on either side of the primary beam with the same intensities (or at least known intensities) ensures that even if the spatial relationship between the light from the specimen and the detector changes, light from spots on the specimen illuminated by at least the primary beam and all of the secondary beams on one side of the primary beam can be detected by the detector. In other words, configuring the optical element for generating secondary beam pairs of the same, lower intensities on either side of the primary beam ensures that if the light from the spot on the specimen illuminated by the primary beam saturates the detector, then signals responsive to the light from spots illuminated on the specimen by the secondary beams having each of the different secondary beam intensities are available for use. In this manner, even if the spatial relationship between the light from the specimen and the detector changes and even if the detector output responsive to the light from the primary beam illuminated spot on the specimen is saturated, the system should generate at least one unsaturated detector output that can be used to determine information for the specimen thereby extending the dynamic range of the system.

In a further embodiment, the optical element is configured such that the secondary beams in a first of the one or more pairs have intensities that are different from intensities of the secondary beams in others of the one or more pairs. For example, each of the secondary beams in one pair preferably have intensities that are different from the intensities of all other secondary beams. In particular, the purpose of the secondary beams in the embodiments described herein is to provide at least one unsaturated detector output that is usable for specimen information determination in the event that light from the primary beam illuminated spot saturates the detector. Therefore, as long as one of the secondary beams produces detector output that is unsaturated, the system can function with an extended dynamic range. As such, as the number of secondary beams that have different intensities increases, the ability to extend the dynamic range will also increase. In this manner, although it is possible that some of the secondary beams on one side of the primary beam could have the same intensities (meaning that the secondary beams in more than one pair have the same intensities), a more advantageous configuration is for all of the secondary beams on one side of the primary beam to have different intensities to increase the probability that for any one specimen location a usable detector output will be generated.

In another embodiment, the optical element is configured such that the secondary beams are symmetrical to each other about the primary beam. For example, each order of the additional beams is preferably a set of symmetric beams on either side of the primary beam at a much lower intensity than the primary beam. In other words, the secondary beams on a first side of the primary beam will be a mirror image of the secondary beams on a second side of the primary beam. The characteristics of the secondary beams that are symmetrical about the primary beam include at least intensity, number of beams, and distance from the primary beam, but possibly other characteristics as well. Again, the symmetry of the secondary beams about the primary beam is advantageous for the same reasons described above, e.g., ensuring that even if the spatial relationship between the beams from the specimen and the detector changes, at least one of the beams incident on the detector will produce an unsaturated output usable for the applications described herein.

In a further embodiment, the optical element is configured such that the secondary beams in at least one of the pair(s) are spaced from the primary beam by substantially the same distance and opposite directions. In other words, the optical element may be configured so that higher order beams of the same order are spaced from the primary beam by the same or substantially the same distance and in opposite directions. For example, the first order, secondary beams may be located on opposite sides of the primary beam and at the same distance from the primary beam. The same may be true for each of the other pairs of higher order beams. In addition, the secondary beams in each pair do not necessarily need to be evenly spaced from each other. For example, if a distance between the primary beam and a first order beam is x, the distance between the first and second order beams does not necessarily have to also be x.

The distance between each of the secondary beams and the primary beams may be kept as small as possible to thereby ensure that light from all of most of the secondary beams on the specimen is detected by the detector. The distance between each of the secondary beams and the primary beam may vary depending on the configuration of the system as long as the beams are far enough apart to avoid any possible overlap on the specimen and at the detector. In a similar manner, the optical element and the other parameters of the system may be configured so that the spots illuminated on the specimen by the primary beam and the secondary beams are as close to each other as possible without any overlap. For example, if the light from a specimen location illuminated with the primary beam is saturated at the detector, then light from a different spot illuminated with a secondary beam that is unsaturated at the detector may be used to determine specimen information for that specimen location. As such, the different spots are preferably sufficiently close to each other on the specimen so that light from each of the different spots is responsive to the same specimen characteristics at or near the specimen location.

Focusing optics of the system are configured for simultaneously focusing the primary beam and the secondary beams to different, spatially separated spots, respectively, in an imaging plane of the system. FIG. 2 shows one embodiment of a multi-spot/beamsplitter and focusing lens. In other words, FIG. 2 shows an embodiment configured for generating the multi-spot illumination via a beam splitter element and with addition of a focusing lens to focus the multiple spots on the same imaging plane. As shown in FIG. 2, the light beam from the light source may be incident laser 200, although the light from the light source may be any other kind of light described herein. Incident laser 200 is directed to DOE 202, which may be configured according to any of the optical element embodiments described herein. Light from the DOE may be directed to lens 204, which although shown in FIG. 2 as a single refractive optical element may have other configurations described herein. Lens 202 is configured to focus the primary and secondary beams (shown simply in FIG. 2 as beams 206) to multiple foci 208 in an imaging plane (not shown).

The system is configured for illuminating the specimen with the different, spatially separated spots in the imaging plane. For example, the specimen (not shown in FIG. 2) may be located at the imaging plane in which multiple foci 208 shown in FIG. 2 are located. In this manner, the focusing optics may be configured to focus the primary and secondary beams directly from the optical element to the specimen. However, as described further herein, one or more additional optical elements may be positioned between the focusing optics and the specimen. As such, the imaging plane to which the focusing optics focus the primary and secondary beams may be an intermediate image plane of the system from which the beams are directed to the specimen. Such additional optical element(s) and the spatially separated illuminated spots on the specimen may be configured as described further herein.

In one embodiment, the optical element is configured such that light from the specimen, due to illumination with the different, spatially separated spots corresponding to the primary beam and at least one of the secondary beams in each of the one or more pairs located on at least one of the opposite sides of the primary beam, is directed by the system to a field of view (FOV) of a detector in the system. For example, configuring the optical element so that there is a secondary beam of each order on both sides of the primary beam is an important and advantageous feature of the embodiments described herein. In particular, the embodiments described herein are configured for generating higher order beams on both sides of the primary beam because where the primary beam will land on the sensor may be unknown.

More specifically, the systems described herein may be configured and set up so that light from the spot illuminated on the specimen by the primary beam will be incident on the detector of the system. However, during scanning of the specimen, the position of the light relative to the specimen and/or the detector may vary for a number of reasons such as variations in height and/or topography of a top surface of the specimen relative to the system. For instance, variations in height of the specimen relative to the system can shift the spatial relationship between the light from the specimen and the detector. In addition, different particles or defects on the specimen may scatter light into somewhat different scattering angles that can affect that spatial relationship.

In this manner, having the beams generated along one direction and symmetrically about the primary beam will effectively guarantee that one set of ghost beams is always in the sensor FOV. Therefore, even if the position of the light from the specimen varies with respect to the detector, the computer subsystem should be able to find at least one unsaturated detector output that can be used for determining information for the specimen. As a result, the embodiments described herein advantageously reduce the sensitivity of the system to unexpected signal saturation and signal drift. In other words, the embodiments described herein can generate usable signals even in the presence of significant detector saturation and drift.

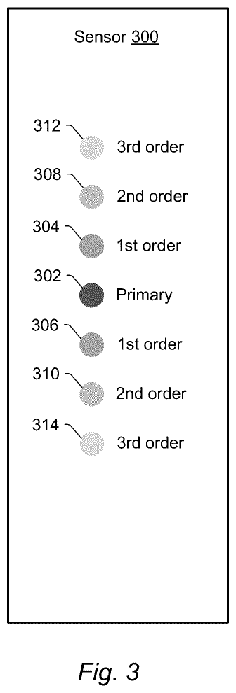

FIG. 3 shows an embodiment of a layout of the light corresponding to the primary and higher order beams with 3 orders on a light detecting area of an imaging sensor. In particular, light 302 from the specimen due to illumination with the primary beam is incident on sensor 300. Light 304 and 306 from the specimen due to illumination with the first order beams in a secondary beam pair is incident on sensor 300 and on either side of light 302. Light 308 and 310 from the specimen due to illumination with the second order beams in a secondary beam pair is incident on sensor 300 and on either side of light 302. Light 312 and 314 from the specimen due to illumination with the third order beams in a secondary beam pair is incident on sensor 300 and on either side of light 302. Although 3 orders of the secondary beams are shown in FIG. 3, the number of the secondary beams may vary as described herein.

The darkness of the light spots shown in FIG. 3 is meant to indicate the relative intensity of the light spots on the sensor which will generally correspond to the relative intensities of the primary and secondary beams. In other words, generally, the relative intensity of each of the light spots on the sensor will be proportional to the relative intensity of each of the primary and secondary beams, even if the intensity of each of the light spots on the sensor is somewhat different than their corresponding primary and secondary beams (e.g., due to the inherent physical limitations of any actual optical system). In this manner, light 302 will generally have the highest intensity on the sensor since it corresponds to the primary beam having an intensity higher than all of the secondary beams, and the intensity of the other light spots on the sensor will generally decrease as the intensity of their corresponding secondary beams decreases.

The characteristics of the light spots on the detector may vary from that shown in FIG. 3, however. For example, the intensities of the light spots on the detector may not have the same relationship to each other as the intensities of the light spots on the specimen (and the intensities of the primary and secondary beams). In one such, non-limiting example, the degree to which the light from any of the spots on the specimen is scattered out of the imaging path of the system may vary from spot to spot, e.g., due to characteristics of the specimen. Therefore, the ratio of detected intensity to illumination intensity for different light beams may be somewhat different from each other. In addition, although each of the spots on the light sensitive area of the sensor is shown in FIG. 3 as a circle, the shape of the spots may vary depending on, for example, the angle of illumination, the angle of collection, characteristics of the specimen, etc. For example, if the system is configured for oblique angle illumination, the spots on the specimen and at the detector imaging plane may be elliptical in shape rather than circular.

As described above, therefore, the configurations of the optical element and the focusing optics generally will control the characteristics of the primary and secondary beams that illuminate the specimen. In general, the configurations of these elements may vary depending on the overall system configuration and the application for which it will be used. In addition, the illumination described herein can be achieved in many different ways, and the actual configuration that is used to implement the embodiments described herein can be designed based on any suitable method or system for optics design known in the art.

An embodiment of a system configured for determining information for a specimen is shown in FIG. 4. In general, the embodiments described herein may be configured as or included in an imaging system. The imaging system may be configured to generate images in different ways as described herein. In addition, the imaging system configuration may vary as described further herein depending on the application for which it will be used such as inspection, metrology, and defect review.

The system includes a light source configured for generating a light beam. For example, system 410 includes at least one light source, e.g., light source 416. The system is configured to direct the light to the specimen at one or more angles of incidence, which may include one or more oblique angles and/or one or more normal angles. As shown in FIG. 4, light from light source 416 is directed through optical element 418 and then lens 420 to beam splitter 421, which directs the light to specimen 414 at a normal angle of incidence. The angle of incidence may include any suitable angle of incidence, which may vary depending on, for instance, characteristics of the specimen and the patterned features to be measured on the specimen.

The system may be configured to direct the light to the specimen at different angles of incidence at different times. For example, the system may be configured to alter one or more characteristics of one or more elements of the system such that the light can be directed to the specimen at an angle of incidence that is different than that shown in FIG. 4. In one such example, the system may be configured to move light source 416, optical element 418, and lens 420 such that the light is directed to the specimen at a different angle of incidence.

In some instances, the system may be configured to direct light to the specimen at more than one angle of incidence at the same time. For example, the system may include more than one illumination channel, one of the illumination channels may include light source 416, optical element 418, and lens 420 as shown in FIG. 4 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the system may include only one light source (e.g., source 416 shown in FIG. 4) and light from the light source may be separated into different optical paths (e.g., based on wavelength, polarization, etc.) by one or more optical elements (not shown) of the system. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, the system may include a spectral filter (not shown) and the properties of the spectral filter can be changed in a variety of different ways (e.g., by swapping out the spectral filter) such that different wavelengths of light can be directed to the specimen at different times. The system may have any other suitable configuration known in the art for directing light having different or the same characteristics to the specimen at different or the same angles of incidence sequentially or simultaneously.

In one embodiment, light source 416 includes a broadband plasma (BBP) light source. In this manner, the light generated by the light source and directed to the specimen may include broadband light. However, the light source may include any other suitable light source such as any suitable laser known in the art configured to generate light at any suitable wavelength(s) known in the art. The laser may be configured to generate light that is monochromatic or nearly-monochromatic. In this manner, the laser may be a narrowband laser. The light source may also include a polychromatic light source that generates light at multiple discrete wavelengths or wavebands.

The system includes optical element 418 positioned in a path of the light beam from light source 416. The optical element is configured as described further herein. For example, the optical element is configured for separating the light beam into a primary beam and one or more pairs of secondary beams. The secondary beams in each of the one or more pairs are located on opposite sides of the primary beam, respectively. The optical element is also configured such that the primary beam has a higher intensity than all of the secondary beams.

In one embodiment, the optical element is configured such that the one or more pairs have intensities that decrease as a distance between the one or more pairs and the primary beam increases. In another embodiment, the optical element is configured such that the secondary beams in a first of the one or more pairs have intensities that are different from intensities of the secondary beams in others of the one or more pairs. These embodiments may also be further configured as described herein.

The system also includes focusing optics configured for simultaneously focusing the primary beam and the secondary beams to different, spatially separated spots, respectively, in an imaging plane at the specimen. For example, light from optical element 418 may be focused to beam splitter 421 by focusing optics that include at least lens 420. The focusing optics and any lens included in the focusing optics may be configured as described further herein. Although lens 420 is shown in FIG. 4 as a single refractive optical element, in practice, lens 420 may include a number of refractive and/or reflective optical elements that in combination focus the light from the optical element to the specimen. The system shown in FIG. 4 may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements based on the type of illumination to be used for imaging.

The system may also include a scanning subsystem configured to cause the light to be scanned over the specimen. For example, the system may include stage 422 on which specimen 414 is disposed during imaging. The scanning subsystem may include any suitable mechanical and/or robotic assembly (that includes stage 422) that can be configured to move the specimen such that the light can be scanned over the specimen. In addition, or alternatively, the system may be configured such that one or more optical elements of the system perform some scanning of the light over the specimen. The light may be scanned over the specimen in any suitable fashion.

The system also includes a detector configured for separately and simultaneously detecting light from the different, spatially separated spots and generating different outputs responsive thereto. For example, the system includes at least one detector, e.g., detector 428 and/or 434. Each of the detectors may be configured for detecting light as described further herein. In particular, the light from the spots illuminated on the specimen by the primary beam and all of the secondary beams on at least one side of the primary beam are preferably incident on the light sensitive areas of at least one or each of the detectors as shown in FIG. 3 and described further herein.

In this manner, when a system is configured to detect light from a specimen with multiple detectors, the embodiments described herein can extend the dynamic range of the system with respect to all of the detectors. In other words, the detector output processing described herein may be performed separately for each of the detectors included in the system so that for each detector and each specimen location being examined, the computer subsystem may find a usable, unsaturated output for information determination purposes. Once the unsaturated outputs generated by each detector for a specimen location have been identified, those output(s) may be processed as described herein or in any other manner. For example, if defect detection is normally performed based on output generated by both detectors shown in FIG. 4, once the computer subsystem has identified an unsaturated output generated by each detector for a specimen location, the computer subsystem may input those unsaturated outputs into a defect detection method or algorithm in the same manner as any other outputs normally generated by the detectors. In other words, the unsaturated detector output identified by the computer subsystem may be used in the same manner as any other detector output for determining information for the specimen. The detectors may be further configured as described herein.

In one embodiment, the optical element is configured such that the light from the different, spatially separated spots, corresponding to the primary beam and at least one of the secondary beams in each of the pair(s) located on at least one of the opposite sides of the primary beam, is separately and simultaneously detected by the detector. This embodiment may be configured as described further herein and advantageously ensures that regardless of the spatial relationship between the light from the specimen and the detector, at least one unsaturated detector output will be generated and available for specimen information determination thereby extending the dynamic range of the system.

The system further includes one or more detection channels. At least one of the one or more detection channels includes a detector configured to detect light from the specimen due to illumination of the specimen by the system and to generate output responsive to the detected light. For example, the system shown in FIG. 4 includes two detection channels, one formed by collector 424, element 426, and detector 428 and another formed by collector 430, element 432, and detector 434. As shown in FIG. 4, the two detection channels are configured to collect and detect light at different angles of collection. In some instances, one detection channel is configured to detect specularly reflected light, and the other detection channel is configured to detect light that is not specularly reflected (e.g., scattered, diffracted, etc.) from the specimen. However, two or more of the detection channels may be configured to detect the same type of light from the specimen (e.g., specularly reflected light). Although FIG. 4 shows an embodiment of the system that includes two detection channels, the system may include a different number of detection channels (e.g., only one detection channel or two or more detection channels). Although each of the collectors are shown in FIG. 4 as single refractive optical elements, each of the collectors may include one or more refractive optical element(s) and/or one or more reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels may be signals or data, but not image signals or image data. In such instances, a computer subsystem such as computer subsystem 436 may be configured to generate images of the specimen from the non-imaging output of the detectors. However, in other instances, the detectors may be configured as imaging detectors that are configured to generate imaging signals or image data. Therefore, the imaging subsystem may be configured to generate images in a number of ways.

In the embodiments described herein, the detectors are clearly configured to separately detect the light from each of the illuminated spots on the specimen. Therefore, each of the detectors should detect light as a function of position. Such detectors may generally include imaging detectors configured so that light from each of the spots can be separately detected on the same light sensitive surface. In this manner, if the spatial relationship between the light from the specimen and one of the detectors changes, light from not all of the spots may be incident on the light sensitive area of that one detector. However, such detectors may include non-imaging detectors that are configured in a similar manner. For example, each detector may include an array of non-imaging detectors, each configured to detect the light from only one of the spots illuminated on the specimen. In this manner, if the spatial relationship between the light from the specimen and the detector varies, then some of the non-imaging detectors in the array may not detect any light. In either case, the output of the detector responsive to the light from each of the spots illuminated on the specimen may be processed as described herein. In particular, regardless of the detector configuration, the computer subsystem will try to find an unsaturated output as described herein and then use only that unsaturated output for specimen information determination.

Computer subsystem 436 of the system may be coupled to the detectors in any suitable manner (e.g., via one or more transmission media, which may include “wired” and/or “wireless” transmission media) such that the computer subsystem can receive the output generated by the detectors during scanning of the specimen. Computer subsystem 436 may be configured to perform a number of functions using the output of the detectors as described herein and any other functions described further herein. This computer subsystem may be further configured as described herein.

This computer subsystem (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, the different computer subsystems may be coupled to each other such that images, data, information, instructions, etc. can be sent between the computer subsystems as described further herein. For example, computer subsystem 436 may be coupled to computer subsystem(s) 402 (as shown by the dashed line in FIG. 4) by any suitable transmission media, which may include any suitable wired and/or wireless transmission media known in the art. Two or more of such computer subsystems may also be effectively coupled by a shared computer-readable storage medium (not shown).

The system also includes a computer subsystem, e.g., computer subsystem 436 and/or computer subsystem 402, configured for determining information for the specimen from the different outputs generated by the detector. The computer subsystem may be configured for determining the information as described further herein, e.g., by methodically identifying an unsaturated output generated by the detector(s) and then determining the information for the specimen from the unsaturated output(s). Once the unsaturated output(s) have been identified by the computer subsystem, the computer subsystem may use the unsaturated output(s) as described further herein and in any other suitable manner to determine the information for the specimen. In other words, once the unsaturated output(s) have been identified by the computer subsystem, they may be input to a defect detection algorithm or method or any other suitable algorithm or method in the same manner as any other detector output would be.

In one embodiment, the computer subsystem is configured for determining the information by determining if a first of the different outputs responsive to the light from one of the different, spatially separated spots illuminated by the primary beam (the “primary beam signal”) is saturated and when the first of the different outputs is not saturated, determining the information for the specimen from only the first of the different outputs. (Although the outputs are referred to herein for the sake of brevity and clarity as simply “signals,” each of the outputs may be any other suitable outputs of the detectors such as images, image signals, image data, etc. whether they are referred to as signals or not.) In other words, if the primary beam signal is not saturated, then the computer subsystem (or an image processing algorithm) may remove outputs responsive to the light from the different, spatially separated spots illuminated by the secondary beams (i.e., the “secondary beam signals” or the signals from the higher order beams) and process only the primary beam signal.

This function should be relatively straightforward as the location of the light corresponding to each of the higher order beams relative to the primary beam is known (e.g., based on the configuration of the optical element and the other elements in the system). In other words, using a known spatial relationship between each of the beams, the computer subsystem can identify the signals corresponding to each of the beams and evaluate them as described herein to find the best unsaturated signal for specimen information determination.

In one such embodiment, when the first of the different outputs is saturated, the computer subsystem is configured for determining if a second of the different outputs responsive to the light from a second of the different, spatially separated spots illuminated by one of the secondary beams closest to the primary beam is saturated and when the second of the different outputs is not saturated, determining the information for the specimen from only the second of the different outputs. In other words, if the primary beam signal is saturated, then the computer subsystem (or the image processing algorithm) will check one of the secondary beam signals corresponding to one of the first order beams, and if that signal is not saturated, then that will be the signal to process and the primary beam signal and other order beam signals will be removed. If the first order, secondary beam signals are also saturated, then the computer subsystem may move onto the second order, secondary beam signals. The computer subsystem can continue this process until a non-saturated signal is found. The achievable number of orders of the secondary beams and their corresponding light spots at the detector may be technically limited by the system, but conceptually, that number is unlimited.

In another embodiment, the computer subsystem is configured for determining the information by: identifying one or more of the different outputs responsive to the light from the different, spatially separated spots that are not saturated; and selecting one of the one or more identified different outputs having a highest intensity among the one or more identified different outputs as the only output used for determining information for the specimen. For example, as described above, the computer subsystem may first determine if the primary beam signal is saturated. If that signal is not saturated, then that may be the only output that is used for determining the specimen information. If that signal is saturated, then the computer subsystem may determine if the next secondary beam signal is saturated, and so on until one unsaturated secondary beam signal is found. That one unsaturated signal is then the only output used for specimen determination. The computer subsystem may alternatively determine which of the primary and secondary beam signals are saturated and which are not. If only one of the signals is unsaturated, then that signal will be automatically selected for further processing. If more than one of the signals is unsaturated, the computer subsystem may then select the non-saturated signal having the highest intensity as the only signal used for specimen information determination. As described above, therefore, there are different ways that the computer subsystem can find the best (e.g., highest intensity) unsaturated signal for use in specimen information determination, which is then the only output used for specimen information determination.

In another such embodiment, the computer subsystem is configured for determining the information from an entirety of the selected one of the one or more identified different outputs. For example, some currently used imaging techniques may use only a non-saturated part of a saturated optical signal for specimen information determination. However, these methodologies can suffer from accuracy issues since the entire signal cannot be used, e.g., only the tail regions where the signal is not saturated can be used. Therefore, relatively small variations in the tail signals, which can be relatively common, can result in relatively large differences in the results. In contrast, the embodiments described herein can use the entirety of an unsaturated signal for specimen information determination. For example, if the primary beam signal is unsaturated, then the output generated by the detector in response to all of light 302 shown in FIG. 3 may be used for specimen information determination. In a similar manner, if the primary beam signal is saturated, but the first order signal is unsaturated, then the output generated by the detector in response to all of light 304 or 306 shown in FIG. 3 may be used for specimen information determination. In this manner, the embodiments described herein can extend the dynamic range of the system without reducing the accuracy of the system.

In one embodiment, a dynamic range of the system is defined by a highest sensitivity achieved with the primary beam to a lowest sensitivity achieved with one of the secondary beams having a lowest intensity. For example, the signal intensity of each order can be selected and designed so that there will be a continued dynamic range from the most sensitivity case with the primary beam to the least sensitivity case with the highest order ghost beam.

In another embodiment, a dynamic range of the system achieved by using only the primary beam or only one of the secondary beams in the one or more pairs for determining the information for the specimen is greater than a dynamic range of the system using only the light beam for determining the information for the specimen. In other words, the embodiments described herein extend the dynamic range achievable by a system with its currently used light beam(s). Configuring and enabling systems such as those described herein with increased dynamic range is an increasingly important and challenging task. For example, for next generation inspection tools, sensitivity is always a basic performance requirement that is preferably improved upon compared to prior tools. However, with improved sensitivity, there is generally a reduction in dynamic range due to the fundamental physics of scattering and electronics. Dynamic range is therefore becoming more critical for users of such tools, and thus the embodiments described herein can be implemented in next generation inspection tools to extend the dynamic range of the system.

The embodiments described herein provide a number of important advantages over currently used methods in addition to those already described. For example, unlike some currently used systems, the embodiments can achieve extended dynamic range without any additional sensor/detector. In addition, the information determinations (e.g., measurements, defect detections, etc.) can be performed by the embodiments described herein based on actual signals within the dynamic range of the sensor thereby eliminating any need for extrapolation. An additional advantage of the embodiments described herein is that a potentially infinite amount of higher order ghost beams can be generated. Therefore, the amount of dynamic range extension can be extended infinitely and is only limited by 1) the relationship between ghost beam separation and sensor size and 2) the control on the ghost beam intensity.

Although the embodiments are described herein with respect to light-based imaging systems, the embodiments are not so limited. For example, generally, in the field of yield-related processes like those described herein, some different energy sources may be used. The systems may be configured for light as described herein, but also or alternatively for charged particles like electrons and ions. In one such example, inspection systems are usually light based, but they may instead use electrons. In charged particle systems, usually signal saturation is less of an issue than in light based systems. However, in instances in which the dynamic range of such systems is limited by image saturation, the same kinds of optical elements described herein may be used in such systems. Obviously, the different types of systems would use different types of beam separators, focusing optics, and detectors, but the concept would be the same. The system would be configured for simultaneous specimen illumination with multiple beams of different “intensity,” the detector would simultaneously detect electrons, etc. from as many of the multiple beams on the specimen as possible, and the computer subsystem would identify the highest “intensity,” unsaturated signal and use only that signal for specimen information determination. Therefore, the same principles described herein can be adapted to non-light systems configured for applications described herein.

In some embodiments, determining the information for the specimen includes detecting defects on the specimen based on the different outputs generated by the detector. For example, once the unsaturated signal has been identified by the computer subsystem as described further herein, the computer subsystem can input the unsaturated signal into a defect detection algorithm or method in the same manner as any other detector output. In perhaps one of the most simple examples, defect detection may include subtracting a reference signal from the unsaturated signal, and the results of the subtraction may be generally referred to as a difference image or difference signal. The defect detection may then include comparing the difference image or signal to a defect detection threshold. Any difference image or signal having a value above the defect detection threshold may be identified as a defect or potential defect, and all other difference images or signals may be discarded. The defect detection algorithm or method into which the computer subsystem inputs the unsaturated signal may include any other defect detection algorithm or method known in the art such as, but not limited to, the MDAT algorithm that is used by some tools commercially available from KLA Corp., Milpitas, Calif.

FIG. 4 is provided to generally illustrate configurations of optical elements that may be included in the system embodiments described herein. Obviously, the system configuration described herein may be altered to optimize the performance of the system as is normally performed when designing a commercial imaging system. In addition, the systems described herein may be implemented using an existing imaging system (e.g., by adding functionality described herein to an existing inspection system) such as the inspection tools that are commercially available from KLA. For some such systems, the embodiments described herein may be provided as optional functionality of the system (e.g., in addition to other functionality of the system). Alternatively, the systems described herein may be designed “from scratch” to provide a completely new imaging system.

The systems described herein may be configured to generate output, e.g., images, of the specimen with multiple modes. In general, a “mode” is defined by the values of parameters of the system used for generating output and/or images of a specimen (or the output used to generate images of the specimen). Therefore, modes may be different in the values for at least one of the parameters of the system (other than position on the specimen at which the output is generated). For example, in an optical system, different modes may use different wavelength(s) of light for illumination. The modes may be different in the illumination wavelength(s) as described further herein (e.g., by using different light sources, different spectral filters, etc. for different modes). In another example, different modes may use different illumination channels of the system. For example, as noted above, the system may include more than one illumination channel. As such, different illumination channels may be used for different modes. The modes may also or alternatively be different in one or more collection/detection parameters of the system. The modes may be different in any one or more alterable parameters (e.g., illumination polarization(s), angle(s), wavelength(s), etc., detection polarization(s), angle(s), wavelength(s), etc.) of the system. The system may be configured to scan the specimen with the different modes in the same scan or different scans, e.g., depending on the capability of using multiple modes to scan the specimen at the same time.

Each of the modes may be configured to use an optical element configured as described herein, and any of the output generated by any of the modes may be processed by the computer subsystem as described further herein. For example, for each mode used to generate output for a specimen location, the computer subsystem may identify the unsaturated output generated by each mode for that specimen location and then use the unsaturated output identified for each mode for determining information for the specimen location. The unsaturated output identified for each mode may be used in the same manner as any other multi-mode output to determine information for a specimen. For example, the unsaturated output identified for each mode may be input to any suitable multi-mode defect detection method or algorithm known in the art.

In one embodiment, the specimen is a wafer. The wafer may include any wafer known in the semiconductor arts. In addition, although some embodiments may be described herein with respect to a wafer, the embodiments are also not limited in the specimen for which they can be used. For example, the embodiments described herein may be used for specimens such as reticles, flat panels, personal computer (PC) boards, and other semiconductor specimens.

The system described herein may be configured as an inspection system, a metrology system, a defect review system, or another type of yield-related tool known in the art. For example, the embodiment of the system shown in FIG. 4 may be modified in one or more parameters to provide different imaging capability depending on the application for which it will be used. In one such example, the system may be configured to have a higher resolution if it is to be used for metrology rather than for inspection. In other words, the embodiment of the system shown in FIG. 4 describes some general and various configurations for an imaging system that can be tailored in a number of manners that will be obvious to one skilled in the art to produce systems having different imaging capabilities that are more or less suitable for different applications.

Computer subsystem 436 and/or 402 shown in FIG. 4 may be configured to generate results that include at least the information determined for the specimen as described further herein. The results may have any suitable format (e.g., a KLARF file, which is a proprietary file format used by tools commercially available from KLA, a results file generated by Klarity, which is a tool that is commercially available from KLA, a lot result, etc.). In addition, all of the embodiments described herein may be configured for storing results of one or more steps of the embodiments in a computer-readable storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. to perform one or more functions for the specimen or another specimen.

Such functions include, but are not limited to, altering a process such as a fabrication process or step that was or will be performed on the specimen in a feedback, feedforward, in-situ manner, etc. For example, the computer subsystem may be configured to determine one or more changes to a process that was or will be performed on the specimen based on the detected defect(s) and/or other determined information. The changes to the process may include any suitable changes to one or more parameters of the process. For example, if the determined information is for defects detected on the specimen, the computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown in FIG. 4) accessible to both the computer subsystem and the semiconductor fabrication system. The semiconductor fabrication system may or may not be part of the system embodiments described herein. For example, the systems described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of the systems described above may be further configured according to any other embodiment(s) described herein.

Another embodiment relates to a method for generating multiple light beams for illumination of a specimen. The method includes separating a light beam (e.g., incident laser 200 shown in FIG. 2) into a primary beam and one or more pairs of secondary beams (e.g., collectively shown as light beams 206) with an optical element (e.g., DOE 202) positioned in a path of the light beam from a light source (e.g., light source 416 shown in FIG. 4). The secondary beams in each of the one or more pairs are located on opposite sides of the primary beam, respectively, and the primary beam has a higher intensity than all of the secondary beams. The method also includes simultaneously focusing the primary beam and the secondary beams to different, spatially separated spots, respectively, (e.g., multiple foci 208 shown in FIG. 2) in an imaging plane of the system. In addition, the method includes illuminating the specimen (e.g., specimen 422 shown in FIG. 4) with the different, spatially separated spots in the imaging plane.

A further embodiment relates to a method for determining information for a specimen. The method includes generating a light beam (e.g., incident laser 200 shown in FIG. 2) with a light source (e.g., light source 416 shown in FIG. 4) and separating the light beam into a primary beam and one or more pairs of secondary beams (e.g., collectively shown in FIG. 2 as light beams 206) with an optical element (e.g., DOE 202) positioned in a path of the light beam. The secondary beams in each of the one or more pairs are located on opposite sides of the primary beam, respectively, and the primary beam has a higher intensity than all of the secondary beams. The method also includes simultaneously focusing the primary beam and the secondary beams to different, spatially separated spots, respectively, (e.g., multiple foci 208) in an imaging plane at the specimen. In addition, the method includes separately and simultaneously detecting light (e.g., light 302, 304, 306, 308, 310, 312, and 314 shown in FIG. 3) from the different, spatially separated spots and generating different outputs responsive thereto. The method further includes determining information for the specimen from the different outputs.

Each of the steps of the each of the methods may be performed as described further herein. The methods may also include any other step(s) that can be performed by the system(s) described herein. The steps of the methods may be performed by the systems described herein, which may be configured according to any of the embodiments described herein.

An additional embodiment relates to a non-transitory computer-readable medium storing program instructions executable on a computer system for performing a computer-implemented method for generating multiple light beams for illumination of a specimen and/or determining information for a specimen. One such embodiment is shown in FIG. 5. In particular, as shown in FIG. 5, non-transitory computer-readable medium 500 includes program instructions 502 executable on computer system 504. The computer-implemented method may include any step(s) of any method(s) described herein.

Program instructions 502 implementing methods such as those described herein may be stored on computer-readable medium 500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 504 may be configured according to any of the embodiments described herein.

Further modifications and alternative embodiments of various aspects of the invention will be apparent to those skilled in the art in view of this description. For example, methods and systems for generating multiple light beams for illumination of a specimen and/or determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for generating multiple light beams for illumination of a specimen, comprising:
an optical element positioned in a path of a light beam from a light source of the system, wherein the optical element is configured for separating the light beam into a primary beam and one or more pairs of secondary beams, wherein the secondary beams in each of the one or more pairs are located on opposite sides of the primary beam, respectively, and wherein the optical element is further configured such that the primary beam has a higher intensity than all of the secondary beams;
wherein focusing optics of the system are configured for simultaneously focusing the primary beam and the secondary beams to different, spatially separated spots, respectively, in an imaging plane of the system; and
wherein the system is further configured for illuminating the specimen with the different, spatially separated spots in the imaging plane.

2. The system of claim 1, wherein the optical element is further configured such that light from the specimen due to illumination with the different, spatially separated spots corresponding to the primary beam and at least one of the secondary beams in said each of the one or more pairs located on at least one of the opposite sides of the primary beam is directed by the system to a field of view of a detector in the system.

3. The system of claim 1, wherein the optical element is further configured such that the one or more pairs have intensities that decrease as a distance between the one or more pairs and the primary beam increases.

4. The system of claim 1, wherein the primary beam and each of the secondary beams are arranged in a one-dimensional array.

5. The system of claim 1, wherein the optical element is further configured such that the secondary beams are symmetrical to each other about the primary beam.

6. The system of claim 1, wherein the optical element is further configured such that the secondary beams in at least one of the one or more pairs are spaced from the primary beam by substantially the same distance and opposite directions.

7. The system of claim 1, wherein the optical element is further configured such that each of the secondary beams in at least one of the one or more pairs has substantially the same intensity.

8. The system of claim 1, wherein the optical element is further configured such that each of the secondary beams in said each of the one or more pairs has substantially the same intensity.

9. The system of claim 1, wherein the optical element is further configured such that the secondary beams in a first of the one or more pairs have intensities that are different from intensities of the secondary beams in others of the one or more pairs.

10. A system configured for determining information for a specimen, comprising:
a light source configured for generating a light beam;
an optical element positioned in a path of the light beam, wherein the optical element is configured for separating the light beam into a primary beam and one or more pairs of secondary beams, wherein the secondary beams in each of the one or more pairs are located on opposite sides of the primary beam, respectively, and wherein the optical element is further configured such that the primary beam has a higher intensity than all of the secondary beams;
focusing optics configured for simultaneously focusing the primary beam and the secondary beams to different, spatially separated spots, respectively, in an imaging plane at the specimen;
a detector configured for separately and simultaneously detecting light from the different, spatially separated spots and generating different outputs responsive thereto; and
a computer subsystem configured for determining information for the specimen from the different outputs generated by the detector.

11. The system of claim 10, wherein the optical element is further configured such that the light from the different, spatially separated spots corresponding to the primary beam and at least one of the secondary beams in said each of the one or more pairs located on at least one of the opposite sides of the primary beam is separately and simultaneously detected by the detector.

12. The system of claim 10, wherein the optical element is further configured such that the one or more pairs have intensities that decrease as a distance between the one or more pairs and the primary beam increases.

13. The system of claim 10, wherein the optical element is further configured such that the secondary beams in a first of the one or more pairs have intensities that are different from intensities of the secondary beams in others of the one or more pairs.

14. The system of claim 10, wherein the computer subsystem is further configured for determining the information by determining if a first of the different outputs responsive to the light from one of the different, spatially separated spots illuminated by the primary beam is saturated and when the first of the different outputs is not saturated, determining the information for the specimen from only the first of the different outputs.

15. The system of claim 14, wherein when the first of the different outputs is saturated, the computer subsystem is further configured for determining if a second of the different outputs responsive to the light from a second of the different, spatially separated spots illuminated by one of the secondary beams closest to the primary beam is saturated and when the second of the different outputs is not saturated, determining the information for the specimen from only the second of the different outputs.

16. The system of claim 10, wherein the computer subsystem is further configured for determining the information by identifying one or more of the different outputs responsive to the light from the different, spatially separated spots that are not saturated and selecting one of the one or more identified different outputs having a highest intensity among the one or more identified different outputs as the only output used for determining the information for the specimen.

17. The system of claim 16, wherein the computer subsystem is further configured for determining the information from an entirety of the selected one of the one or more identified different outputs.

18. The system of claim 10, wherein a dynamic range of the system is defined by a highest sensitivity achieved with the primary beam to a lowest sensitivity achieved with one of the secondary beams having a lowest intensity.

19. The system of claim 10, wherein a dynamic range of the system achieved by using only the primary beam or only one of the secondary beams in the one or more pairs for determining the information for the specimen is greater than a dynamic range of the system using only the light beam for determining the information for the specimen.

20. The system of claim 10, wherein determining the information for the specimen comprises detecting defects on the specimen based on the different outputs generated by the detector.
